(19) United States
(12) Patent Application Publication
(10) Pub. No.: US 2024/0412750 A1
(43) Pub. Date: Dec. 12, 2024

(54) MULTI-MICROPHONE AUDIO SIGNAL UNIFIER AND METHODS THEREFOR

(71) Applicant: Intel Corporation, Santa Clara, CA (US)

(72) Inventors: Przemyslaw Maziewski, Gdansk (PL); Lukasz Pindor, Pruszcz Gdanski (PL); Sebastian Rosenkiewicz, Gdansk (PL); Adam Kupryjanow, Gdansk (PL)

(73) Assignee: Intel Corporation, Santa Clara, CA (US)

(21) Appl. No.: 18/206,742

(22) Filed: Jun. 7, 2023

(51) Int. Cl. G10L 21/0232; G10L 25/30; H04R 3/00

(52) U.S. Cl. CPC G10L 21/0232; G10L 25/30; H04R 3/005

(57) ABSTRACT

A system, article, device, apparatus, and method for a multi-microphone audio signal unifier comprises receiving, by processor circuitry, an initial audio signal from one of multiple microphones arranged to provide the initial audio signal. This also includes modifying the initial audio signal comprising using at least one neural network (NN) to generate a unified audio signal that is more generic to a type of microphone than the initial audio signal.

### BACKGROUND

Many people use multiple types of microphones to increase productivity at a computer. Thus, a user often has an option to use internal microphones on a laptop or a headset that can be paired to the laptop or coupled to the laptop through a cable. During a phone or video conference, the user may switch between the microphone types for convenience. Users at remote audio output devices emitting the audio from the source, however, often can detect the change in microphone due to a change in the sound of the source user's voice as well as differences in background sounds, which can be very distracting and annoying.

### DESCRIPTION OF THE FIGURES

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a schematic diagram of an acoustic environment with a user at multiple user sources and multiple microphones according to at least one of the implementations disclosed herein;

FIG. 2 is a schematic diagram of another acoustic environment with a user at multiple user sources and multiple microphones according to at least one of the implementations disclosed herein;

FIG. 3 is a schematic diagram of yet another acoustic environment with multiple microphones and a moving user according to at least one of the implementations disclosed herein;

FIG. 4 is a schematic diagram of an audio processing system to generate a unified audio signal according to at least one of the implementations described herein;

FIG. 5 is a schematic diagram of a platform sound unifier of the system of FIG. 4 and according to at least one of the implementations described herein;

FIG. 6 is a flow chart of an example method of modifying an initial audio signal to provide a unified audio signal according to at least one of the implementations described herein;

FIG. 7 is a flow chart of an example method of training a neural network to perform modifying of an initial audio signal to provide a unified audio signal according to at least one of the implementations described herein;

FIG. 8 is a schematic diagram of audio datasets for input to an audio signal unifying neural network arrangement according to at least one of the implementations described herein;

FIG. 9 is a schematic diagram of a training system to train an audio signal unifying neural network according to at least one of the implementations described herein;

FIG. 10 is a schematic diagram of the neural network of FIG. 9 in a run-time pipeline according to at least one of the implementations described herein;

FIG. 11 is an illustrative diagram of an example system;

FIG. 12 is an illustrative diagram of another example system; and

FIG. 13 illustrates another example device, all arranged in accordance with at least some implementations of the present disclosure.

### DETAILED DESCRIPTION

One or more implementations are now described with reference to the enclosed figures. While specific configurations and arrangements are discussed, it should be understood that this is performed for illustrative purposes only. Persons skilled in the relevant art will recognize that other configurations and arrangements may be employed without departing from the spirit and scope of the description. It will be apparent to those skilled in the relevant art that techniques and/or arrangements described herein also may be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes unless the context mentions specific structure. For instance, various architectures employing, for example, multiple integrated circuit (IC) chips and/or packages, and/or various computing devices and/or consumer electronic (CE) devices such as laptop, desktop, or other personal (PC) computers, tablets, mobile devices such as smart phones, smart speakers, or smart microphones, conference table console microphone(s), video game panels or consoles, high definition audio systems, surround sound, or neural surround home theatres, television set top boxes, on-board vehicle systems, dictation machines, and so forth, may implement the techniques and/or arrangements described herein. Further, while the following description may set forth numerous specific details such as logic implementations, types and interrelationships of system components, logic partitioning/integration choices, and so forth, claimed subject matter may be practiced without such specific details. In other instances, some material such as, for example, control structures and full software instruction sequences, may not be shown in detail in order not to obscure the material disclosed herein. The material disclosed herein may be implemented in hardware, firmware, software, or any combination thereof.

The material disclosed herein also may be implemented as instructions stored on a machine-readable medium or memory, which may be read and executed by one or more processors. A machine-readable medium may include any medium and/or mechanism for storing or transmitting information in a form readable by a machine (for example, a computing device). For example, a machine-readable medium may include read-only memory (ROM); random access memory (RAM); magnetic disk storage media; optical storage media; flash memory devices; electrical, optical, acoustical or other forms of propagated signals (e.g., carrier waves, infrared signals, digital signals, and so forth), and others. In another form, a non-transitory article, such as a non-transitory computer readable medium, may be used with any of the examples mentioned above or other examples except that it does not include a transitory signal per se. It does include those elements other than a signal per se that may hold data temporarily in a “transitory” fashion such as RAM and so forth.

References in the specification to “one implementation”, “an implementation”, “an example implementation”, and so forth, indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described herein.

As used in the description and the claims, the singular forms “a”, “an” and “the” are intended to include the plural forms as well, unless the context clearly indicates otherwise. It also will be understood that the term “and/or” as used herein refers to and encompasses any and all possible combinations of one or more of the associated listed items.

Systems, articles, platforms, apparatuses, devices, and methods for a multi-microphone audio signal unifier.

On a phone or video conference, speech and other acoustic signals provided by different microphones connected to a source device sound different at a receiving output or emission device with speakers to emit the audio. Thus, when a user changes the microphone at the source device, the changes in sound can be perceived at the output device, sometimes for better, and sometimes for worse, but usually in a random manner from the output user's point of view at the output device. The change in perception is the result of many different audio recording parameters including differences in the acoustic environment such as directional characteristics (such as an angle of arrival from source (e.g., person speaking) to microphone), room acoustics, and location (or distance) between the microphone being used and the source or user speaking. Other parameters relate to the structure and quality of the microphone, audio equipment being used with the microphone, and audio processing. These parameters may include noise characteristics (such as a signal-to-noise ratio (SNR) or internal (or intrinsic) noise), equalization settings, microphone sensitivity, and microphone directivity. Note that output device herein always refers to the device associated with outputting or emitting audio such as by being, or being coupled to, one or more speakers and to be heard by an output user.

Conventional methods to improve the audio signals in voice calls or audio recordings typically involve an audio enhancement multi-module pipeline. Such a pipeline often has a reverberation reducer (DRV), equalizer (EQ), dynamic noise suppressor (DNS), and AGC (automatic gain controller). Such systems may reduce the effect on audio signals caused by different acoustic environments around a microphone. However, such systems do not reduce the differences of characteristics of audio signals from microphone to microphone, thereby resulting in annoying changes at the output device when the microphones being used is switched.

Some neural networks can convert an audio signal for one microphone as if it was recorded on another microphone. This type of neural network, however, requires training with audio signals from both known microphones involved in the conversion: the microphone to be used during a run-time (the end microphone at an end device) and the microphone that is being converted to or copied (the copied microphone), for a 1:1 supervised microphone training configuration. This training pair process must be repeated for each different microphone that is going to be used or copied. Thus, the training of such a system is very labor intensive since data must be collected on the end device or mic to be used for every different microphone to be copied and to train the model in the cloud or to train on the end device (e.g., on a laptop to be used during a run-time). In practice, however, and for cloud computing, such data collection is very limited due to privacy issues. Also, the audio subsystem on an end device with microphones typically has audio processing neural network circuitry and programming that only permits inferences on the end device, and does not have hardware, or hardware capacity, and/or programming for training each microphone to be copied.

To resolve these issues, the disclosed method, device, and system reduce the differences in audio signal characteristics from microphones at an input or source device (also referred to as a recording device, source platform, or just platform) so that it is more difficult to perceive a change in microphone type as perceived by an output user listening to the audio emitted at an output device. This effect also will result in reductions in perceptible differences in the audio when the source moves relative to microphones, the room acoustics change, and other environmental differences. As a result, users at the output device may have better or good sound quality regardless of the type of microphone being used at the source device.

More specifically, the disclosed method and systems use a platform sound unifier (PSU) with a neural network (NN) arrangement with NNs or models that modify initial audio signals captured by a microphone that may be one of multiple microphones on various source devices available to a source or user speaking. The system modifies the initial audio signals to generate a more unified or generic audio signal so that the audio signals sound more similar or the same regardless of the microphone type and particular microphone being used at the input or source device. The microphones will sound more similar or the same because unified audio signals of each microphone generated by the PSU will have audio signal characteristics that are closer to a generic audio signal. In other words, it is understood the NN inherently generates or models a generic audio signal to be able to modify the characteristics of the initial audio signal, no matter the microphone, to be closer to the characteristics of a generic audio signal of the NN. Thus, the unified audio signals of multiple microphones may become more alike in any combination of audio signal characteristics which is generally covered by characteristics such as frequency response, signal-to-noise ratio (SNR), and/or total harmonic distortion of the initial audio signals. Other more specific characterizations that fall under these categories may include intrinsic noise and the level of nonlinear distortion, as well as other audio signal characteristics not listed here.

This also enables the microphones to sound more similar or the same despite differences in distance and direction (angle of arrival (AoA)) between the source and each microphone on a source device. Such reduction in differences in distance and angle changes, however, may be indicated (or in other words, inherently included) by the adjustments in frequency response, SNR, and total harmonic distortion. It should be noted here that the audio signal provided from the microphones and to be converted into a unified audio signal is labeled ‘initial’ relative to the resulting unified audio signal, and is not meant to suggest any other specific stage or version of the audio signal on an audio processing pipeline.

The modified or unified audio signal is then provided to an output device to emit the audio through speakers, or to be used by other audio processing applications such as automatic speech recognition, and so forth.

This method and system is accomplished by training a neural network (NN) of the PSU to receive initial audio signals and output the unified audio signals. The NN is trained as part of a NN arrangement that receives a first or source dataset as input and with audio signals of multiple unknown microphones of various types and comparing the generated modified (or fake) audio signals with a second or target dataset of target audio signals of target microphones of the same type of microphone, such as a head phone, built-in mobile phone microphones, built-in tablet microphones, built-in laptop microphones, studio microphone, free-standing microphone, and so forth. By one approach, a different NN model may be provided for each different target dataset with a different type of microphone used to train the neural network arrangement. Then during a run-time, the user or system can switch to the model of the type of microphone providing an initial audio signal at the source device. An unknown microphone is one that may be used for training by a manufacturer but is not the specific microphone on a source device used by an end-user or consumer to record or obtain audio during a run-time for example.

By one approach, the neural network arrangement is a cycle generative adversarial network (cycleGAN) that has two generative NNs including a source to target NN and a target to source NN, and two discriminative NNs including a discriminative target NN and a discriminative source NN. The generative NNs generate fake or modified audio signals (or potential unified audio signals), while the discriminative NNs determine whether or not the fake audio signals are real or fake. The fake signals of each generative NN also may be input to the opposite generative NN in order to use the generative NN output to generate cycle loss function values that indicate the coherence or consistency of the NN arrangement. The output of the discriminative NNs are used to generate the loss function values of the generative NNs. These three loss functions are then used to form a total loss function value. The neural network arrangement is sufficiently trained when loss function computations come to a predetermined threshold convergence or other criteria. The generative source to target neural network in the neural network arrangement then can be used during a run-time by end-users.

The resulting platform source unifier (PSU) can enable microphones connected to the same platform to sound the same (or at least much more similar), no matter the endpoint microphone type, i.e., build-in mic, headset, and so forth. The PSU generates more generic or unified audio signals captured in various acoustic conditions so that the audio signal has characteristics closer to predefined uniform or generic audio signal characteristics of a generic audio signal of a certain microphone type, as mentioned above and inherently established by the neural network. Such a NN-based PSU may be operated by firmware or software with or without dedicated hardware, any of which provides a very low footprint.

While the unintentional result of the neural network may be to improve the audio signal, such as by a reduction in noise and/or reverberation reduction, this is merely an extra benefit. Thus, actually, the PSU neural network provides the modified or unified audio signal regardless of improvements in the characteristics of an initial audio signal input to the neural network. By other alternatives, the PSU NN could be combined with another NN or algorithm that is provided to improve the characteristics of the audio signals. Otherwise, other audio signal enhancement units may be provided before or after the PSU NN as desired herein to improve or clean the audio signals. The PSU can be placed easily within existing audio processing pipelines.

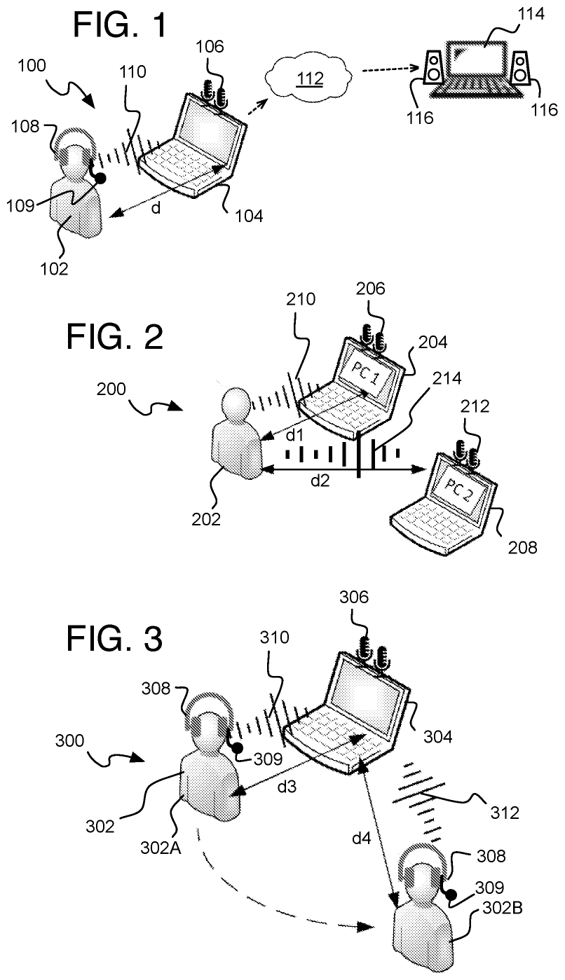

Referring to FIG. 1, an example audio setup (or system) 100 can benefit from the disclosed multi-microphone audio signal unifier methods and systems herein and is an example acoustic multi-microphone environment that may be located in a room of a building, for example, or may be at some other location whether outdoors or indoors. The setup 100 may have a user 102 located in front of an audio or source device 104 with representative microphones 106 of the audio device 104. In this example, the audio device is a laptop, and the microphones 106 may be built-in or internal microphones that actually are within a case of the laptop 104 and cannot be seen. Other options include external microphones that are wired or wirelessly coupled to the laptop. Many variations exist. In this example, the user 102 also may be wearing a headphone or headset 108 which itself may be a source device and is wired or wirelessly coupled to the other source device 104. The headphones 108 may have its own one or more microphones 109, such as on a microphone wand, in line with a headphone cable, or internal on the speaker cups or headphone frame. The external source devices may be referred to as peripheral devices as well when the external devices are coupled by relatively short distance to either another source device, a host device hosting a teleconference or video conference, or other device that is to transmit the audio signals and/or perform the audio signal unifying analysis.

Many variations in the type of source devices may be used such as mobile devices including smart phones and tablets, and studio, free-standing, or WiFi/internet microphones to name a few examples. The type and number of microphones is not limited as long as the microphones can convert acoustic waves into a raw audio signal and can be networked to provide the signals to a platform or multi-microphone audio signal unifier unit or platform sound unifier (PSU) unit. The devices 104 and 108, and in turn microphones 106 and 109 on those devices, may be in any position relative to each other within the acoustic environment of audio setup 100 as long as the microphones 106 and 109 of the devices 104 and 108 can capture the audio emitted by the source or user 102 adequately for analysis to generate unified audio signals as described herein.

The user (or source) 102 is shown speaking and emitting acoustic waves or audio 110 and while at a fixed position including a fixed distance d between the source 102 and the source device 104 (and mics 106), and with the user's head pointing at a fixed angle relative to the source device in both azimuth (horizontal) and elevational (vertical) angles. The user may be switching microphones between the microphones 109 on the headset 108 and the mics 106 on the audio device 104 as desired, or the switching may occur automatically by the system.

The audio device 104 may receive audio signals from either the audio device microphones 106 or microphones 109 on the headset 108, and generate a unified or more generic audio signal. The audio signal may be transmitted through a computer or communications network 112 to an output device 114 with speakers 116. At the output device 114, the audio is played using the unified audio signal so that it is more difficult (or impossible) for a user at the output device 114 to detect that the microphones had been switched at the source devices 104, thereby reducing annoying distractions to provide a higher quality audio experience.

The network 112 may be any desirable network whether a wide area network (WAN), local area network (LAN), or even a personal area network (PAN). The network 112 may be, or include, the internet, and may be a wired network, wireless network or a combination of both. Any of the source (or listening) devices may be coupled to each other, a host device, and/or a device performing the unified audio signal analysis through network 112 or another network.

The output device 114 shown here is a laptop, desktop, tablet, or other computer, server, or other output device with one or more speakers 116 (here shown as external speakers, but could be internal speakers, or any desired speakers). Optionally or additionally, the output device 114 may be any adequate audio emission device including being one or more speakers itself, whether or not smart speakers or any other smart device with one or more speakers, hearing aids, and so forth. Although the output device may be in the same environment as the source 102, in most cases one or more, or all, of the output devices 114 should be remote from, or external to, the acoustic environment of audio setup 100, and may be coupled to network 112, via wireless or wired connection, or both. The network 112 and output device 114 is the same or similar for setups 200 and 300, and do not need to be described again for those setups.

Referring to FIG. 2 for another example, a user 202 is in a similar setup 200 compared to that of setup 100 (FIG. 1) where the user 202 is speaking and emitting audio 210 in front of an audio or source device 204 that may be a laptop with microphones 206, all of which are as described in setup 100. The user 202 is still in a fixed position (fixed angle and fixed distance d1 in this case) to the laptop (PC1) 204. In this case, however, the user 202 is emitting audio in the presence of another audio, source, or computing device (PC2) 208 with one or more microphones 212, here being two laptops rather than wearing a headset. The user 202 will have a different distance d2 to the second audio device 208 compared to the first distance d1, and an audio emission 214 in a different speaking or emitting direction than the direction of distance d1, and in turn the microphones 206 and 212 will have different angles of arrival (AoA).

In this case, either or both the source devices 204 and 208 may perform the multi-microphone audio signal unifier analysis (as the unifying device), and either or both devices or computers 204 and 208 may provide a unified audio signal to be sent to an output device. In this case, the two source devices 204 and 208 are coupled to each other in the same computer network to provide the initial audio signals of the microphones 206 and 212 to whichever of the two devices (or another device) that unify the audio signals. In this case, the disclosed audio signal unifier methods and system may provide a unified audio signal with more generic audio signal characteristics that reduce the differences between the unified audio signals of the microphones compared to the differences between the initial audio signals of different microphones not only in intrinsic influences of the characteristics, but also extrinsic influences caused by the change in angle and distance between microphones 206 on one source device 204 and microphones 212 on the other source device 208.

Referring to FIG. 3 for yet another example audio setup 300, a user 302 has an initial position 302A in front of a source or audio device 304 with speakers 306, as described above with setup 100, and where the user 302 is wearing a headset 308 with one or more microphones 309. The user is a distance d3 from the source device 304 and is emitting audio 310 straight toward the source device 304. In this example, the user 302 may move to one or more other positions 302B that may or may not have audio 312 emitted along a different distance d4 from the source device 304 compared to distance d3, and may be at a different vertical or horizontal angle relative to such angles in the initial position 302A. It should be noted in this case, the audio signal characteristics from the laptop microphones 306 may change substantially while the audio signal characteristics of the headphone microphones may not change at all or very little since the microphone moves with the user 302. As with setup 200, here too, whether the source device 304 or a different host or other device is performing the unifying analysis, the resulting unified audio signals sent to the output device should have audio signal characteristics that indicate both a reduction of extrinsic and intrinsic differences of audio signal characteristics among the source between the source devices 304 and 308. Also, it may be more difficult for the user at the output device to be able to detect that the user 302 is moving while wearing the headphones 308 when the output device receives the unified audio signals.

As with the setup 100, the microphones may be switched manually by the user or automatically by the system. Also for any of the setups, the audio signal unifying system may permit a user to select the microphone type (or the system may do it automatically) to match the microphone type that is being used before (or after) changing that microphone type. As explained below, a different, more precise or customized neural network model can be provided for each different type of microphone. This selection may be provided directly on the source device whether or not the source device is performing the unifying analysis. Thus, by some examples, when the source device is remotely coupled to unifying device that is performing the unifying analysis, the selection may be transmitted to the separate unifying device to generate the unified audio signals.

By one alternative in the example herein, the source device 104, 204, or 304 may be a host device. Specifically, the host device refers to the device that is hosting and initiating a video or phone conference, and for ease of explanation, it is assumed the host device can perform the unified audio signal generation and other desired audio processing tasks. Otherwise, a host device hosting a video or teleconference and performing the unified audio signal generation may not be within environment 100, 200, or 300. Thus by one form, the host device may be a server communicating with the user's laptop 104, 204, or 304. However, the host device and unified audio signal generation could be on different devices as well.

By one example alternative, it also will be appreciated that the audio signal unifying could work with a single listening device that has multiple microphones. Thus, a single device such as a laptop may initiate a teleconference with remote output devices, have microphone switching circuitry to switch between 2 or more built-in microphones on the laptop, and modules (or units) to perform audio signal unifying to output a unified output signal as described herein. The generation of the unified audio signal here, however, will be described when multiple separate listening devices are coupled to a single source or audio device (or host device or unifying device) that will provide the unified audio signals.

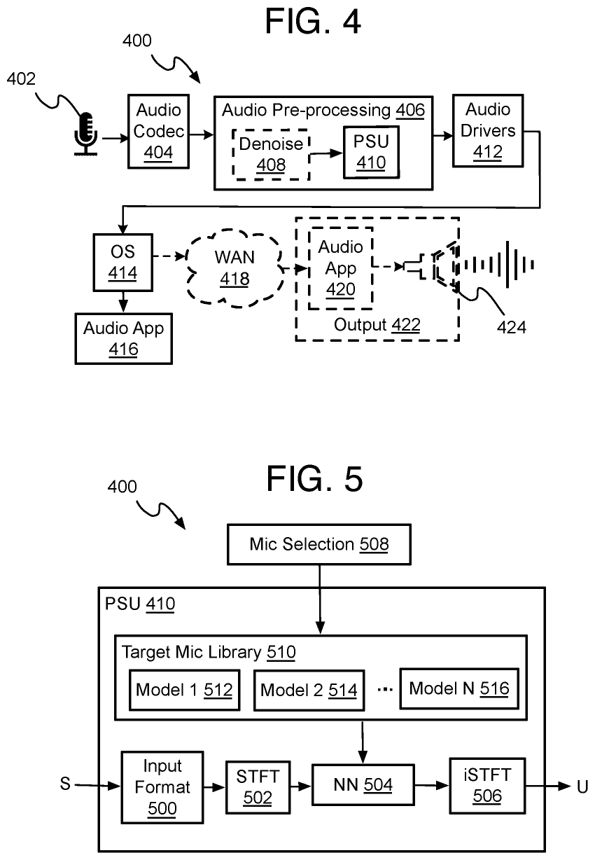

Referring to FIG. 4, an example audio processing system 400 may perform the unified audio signal generation disclosed herein. The operation of the system 400 during a run-time is explained in detail with process 300 and the training of a neural network used by the system 400 is explained with process 600. The system 400 may have a source device 402, which may be or have a microphone that is providing an initial audio signal during a run-time, an audio pre-processing unit 406 (also referred to as an audio signal unifying device or unit, or just unifying device), audio drivers 412, an operating system (OS) 414, and optionally audio applications 416. By one form, all of the components just mentioned are on a single source device, such as a laptop 104 (FIG. 1). By another form, any one combination of the units may be on separate devices. Thus, the audio signal unifying unit 406 (such as a server for example) may be on a different device than the audio drivers 412 and OS 414 shown here. Many variations can be used.

The system 400 may have multiple microphones with at least one microphone on each of multiple source devices as described with setup 100 (FIG. 1). By one form, at least two source devices with microphones are being used. Only the microphone (or source device) 402 that is providing an initial audio signal during a run-time is shown here on system 400 for clarity. Thus, microphone 402 may represent a built-in microphone on a laptop, or may be such a laptop, or may represent a microphone on a headphone, or may be the headphones, and so forth.

By one form, each source device has a single microphone that can provide an initial audio signal for analysis. By an alternative form, however, some source devices may have multiple microphones or microphone arrays such as binaural headphones or a smartphone or tablet (or even the laptop described above) with four or more microphones by one example. In these cases, either the source device itself may combine the separate audio signals from separate microphones into a single initial audio signal or the separate audio signals may be transmitted to the unifying device or unit 406 generating the unified audio signal. In the latter case, the unifying device 406 may combine the separate audio signals into a single initial audio signal before being provided for unified audio signal generation. System 400 may be arranged to use these alternatives where a single initial audio signal is provided from a source device to the PSU 410.

By yet another alternative, however, the separate audio signals could each be analyzed and modified into a separate unified audio signal, and either the separate unified audio signals are provided for further use such as for 3D sound applications, or the separate unified audio signal with the best audio quality (or other criteria) can be selected for further use. Otherwise, the separate unified signals then could be combined into a single unified audio signal for further use. Many variations are contemplated.

By one form, each microphone or source device with a microphone may perform at least some local or internal pre-processing operations before being sent to the unifying device 406. Thus, the microphone or source device 402 may perform or have its own acoustic echo cancellation (AEC) circuitry, analog-to-digital (A/D) converter, denoising, dereverberation, automatic gain control (AGC), beamforming, dynamic range compression, and/or equalization, and so forth.

The audio codec circuitry or unit 404 receives the initial audio signal, which may be a digital version. When the microphone 402 is external to the audio pre-processing unit (or unifying unit) 406, the audio codec unit 404 may encode the initial audio signal for transmission to the audio pre-processing unit 406, which then decodes the audio signal. A denoising unit 408 then may receive the initial audio signal and may apply known denoising techniques when desired. Otherwise, a platform self-noise silencer (PSNS) may be used to specifically reduce intrinsic or self-noise by using a PSNS neural network trained to recognize self-noise of a microphone. The self-noise then may be filtered out of the initial audio signal by the audio codec unit 404, and/or other components of the system 400. Also, the audio pre-processing unit 406 may perform other pre-processing tasks as desired, such as any of those mentioned above with the microphone's local pre-processing, and before providing the initial audio signal to a platform sound unifier (PSU) or PSU unit 410 to generate a unified audio signal.

Once the PSU 410 generates a unified audio signal, audio drivers 412 may be provided to interface with the operating system (OS) 414, which may provide the unified audio signal for use by one or more of applications 416. The applications 416 may include a phone or video conference application, or other audio application, when the audio pre-processing unit 406 is a host device. Also, the application 416 may prepare the unified audio signal for rendering or presentation to a user. For instance, the unified audio signal may be presented at speakers of the same user computing devices where the initial audio signal was recorded by the microphone 402. Otherwise, the unified audio signal may be transmitted over a network or wide area network (WAN) 418 to audio applications 420 at a remote host device or output device 422 for emission over one or more speakers 424 or for further audio processing such as automatic speech recognition (ASR), speaker or voice recognition (SR), angle of arrival (AoA) detection or beamforming, and so forth.

While the network 418 is shown as a WAN, such as the internet, the network 418 may be a local area network (LAN), personal area network (PAN), or other computer or communications network. By one form, the network is any typical office or residential WiFi network, such as a D2D (WiFi direct) network or any WiFi network.

Referring to FIG. 5, the example platform sound unifier (PSU) unit 410 may have an input format circuitry or unit 500, a short-time Fourier Transform (STFT) unit 502, a neural network 504, an inverse short-time Fourier Transform (iSTFT) unit 506, a mic selection unit 508 which may or may not be considered separate from the PSU 410, and a target mic library 510, with target models 1 (512) to N (516) that are stored in memory. The input format unit 500 may divide the initial audio signal, provided in the form of samples, into frames, and by one form, overlapping frames according to a hop length, and otherwise converts the audio signals into a format and/or version expected by the NN 504. By one form, the STFT unit 502 may or may not be considered part of the input format unit 500, and may perform domain conversion to convert the initial audio signal frames into the frequency domain, and particularly in one example, to perform feature extraction to provide feature vectors of Mel-frequency band (or spectrum or bin) values as the input to the NN 504. The frames may be placed into a NN input buffer (not shown) for retrieval to be input to the NN 504 as desired and arranged. The input buffer may have many different configurations.

To operate the NN 504, the mic selection unit or circuitry 508 may provide, or be coupled to, a user interface (not shown) for a user to select a microphone type that is to provide the initial audio signal, such as an option to select among source devices such as: headphones, laptop, mobile phone, tablet, studio mic, stand-alone mics, and so forth. Alternatively, or additionally, the microphone choices may be more specific by providing choices among specific microphone types such as “internal laptop mics” or “built-in laptop mics”, and/or specific microphone products or brands may be listed instead. Thus, the term ‘type’ here may be a general microphone device category or something more specific as long as each type available from the PSU 410 has a different corresponding target microphone model here shown as models 1 512 to model N 516. No limit exists as to the number of types and models except that the number may be associated with what is practical or efficient to operate the PSU 410. Each different available type of microphone should have its own target microphone model in the target microphone library 510 accessible on, or by, the PSU 410.

By an alternative, the mic type selection at the microphone selection unit 508 may be performed automatically by either a paired or coupled source device 402 transmitting a device identification to the microphone selection unit 508, or by the audio pre-processing unit 406 detecting the type of microphone that is being used. Other details and alternatives of the selection are provided below.

One or more of the frames then may be placed in the input surface or layer for the NN 504. By one example architecture, the NN 504 is a type of U-net NN, and by another form, the NN 504 is a generative source-to-target NN trained as part of a type of GAN or cycleGAN NN arrangement described in detail below. The frames of the initial audio signal are then propagated through the NN 504 of one of the target models 512 to 516 selected at the mic selection unit 508.

By one approach, the audio pre-processing unit 406, and in turn the PSU 410, is in the form of firmware. The Hardware used to operate the NN 504 may include accelerator hardware such as a specific function accelerator with one or more multiply-accumulate circuits (MACs) to receive the NN input and additional processing circuitry for other NN operations. By one form, either the accelerator is shared in a context-switching manner, or one or more accelerators may have parallel hardware to perform unified audio signal generation on different parts of the initial audio signals in parallel. By one form, the NN 504 then outputs or provides a unified audio signal that may be stored in an output buffer (not shown) for further use. A resulting output unified audio signal then may be provided to the inverse STFT unit 506 to derive a time-domain unified audio signal U for further use.

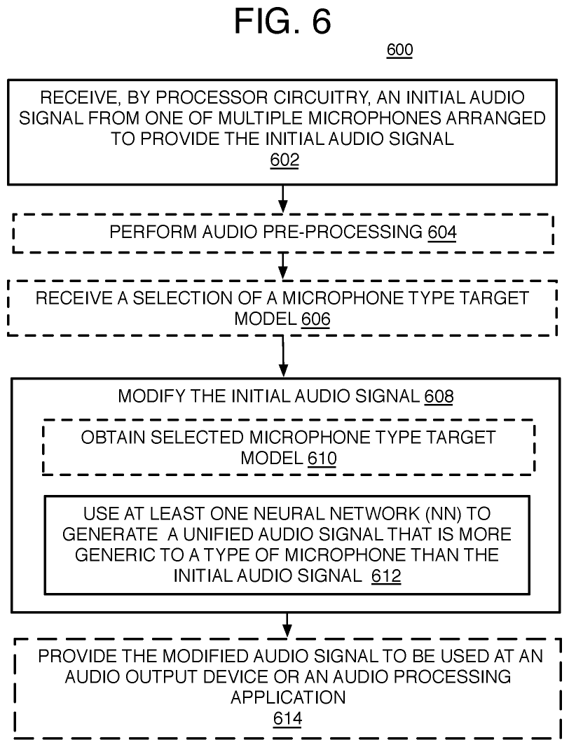

Referring to FIG. 6, an example process 600 for a computer-implemented method of operating a multi-microphone audio signal unifier to generate unified or modified audio signals during a run-time is provided. In the illustrated implementation, process 600 may include one or more operations, functions, or actions as illustrated by one or more of operations 602 to 614 at least generally numbered evenly. By way of non-limiting example, process 600 may be described herein with reference to example devices, systems, or environments 100, 200, 300, 400, 500, and 1100, network datasets 800, and networks 900 and 1000 described herein with FIGS. 1-5, 8-11, or any of the other systems, processes, environments, or networks described herein, and where relevant.

Process 600 may include “receive, by processor circuitry, an initial audio signal from one of multiple microphones arranged to provide the initial audio signal” 602. This may include many different types of audio environments with many different types of microphones on input or source devices each with at least one microphone. By one example, the microphones may be one or more built-in microphones on a laptop and a headphone microphone where the user at these source devices can switch between the microphones as is convenient or desired, and/or one of the source devices, an audio signal unifying device, or a host device may switch the microphones automatically. This also could include the alternative of having a single source device, such as a laptop, smartphone, or tablet, with two or more built-in microphones and that either provides separate initial audio signals or combines the separate audio signals into a single initial audio signal to provide a single audio signal from the source device for further audio processing.

This operation also includes that the source devices with the microphones are communicatively coupled or paired to a microphone unifying device with the PSU (such as on system 400 (FIG. 4)) if these devices are remote from each other. This also may have many different variations. For example during an audio (or phone) or video (or audio/video (AV)) conference, the source devices, a conference host device, and an audio signal unifying device should all be coupled directly or indirectly to the same network to operate the conference. These devices may be remote from each other or any combination of these devices may be combined into a single device. Thus, in one example, one of the source devices (a laptop for example) also may be the host device and the audio signal unifying device. Many variations are contemplated.

In addition, it should be noted that the process 600 is operated during a run-time and live (or real time) for any audio processing application as described herein, and instead of training of a neural network of the platform sound unifier.

During a phone or video conference, the microphones convert the captured audio, or audio waves, into audio signals which may include amplitudes in the whole frequency spectrum, or at specific frequencies or frequency bands, that correspond to audio intensity for example. Thus, each microphone senses acoustic waves that are converted into a raw audio signal to be transmitted from the source device of the microphone and on a separate audio signal channel to the host device and unifying device to perform the microphone audio signal unifying.

Process 600 may include perform “perform audio pre-processing” 604, and as described above, each mic or source device may perform internal or local pre-processing, and/or the audio pre-processing unit with the PSU also may perform pre-processing before the initial audio signal is provided to the PSU. This may provide a cleaner signal to the PSU which may increase the reduction of microphone differences in audio signal characteristics. In some cases, however, the local pre-processing at the microphones or source devices could provide unexpected audio signal data to the neural network of the PSU that results in ineffective audio signals that do not reduce microphone characteristic differences. In these cases, the initial audio signal of such a microphone will not be used when no way exists to automatically or manually disable the extra local pre-processing.

Process 600 may include “receive a selection of a microphone type target model” 606. This can be performed manually by a user or automatically. When a manual selection of microphone type is provided, one of the devices, whether a source device, a host device, or the unifying device may have the microphone selection unit (508 on FIG. 5) provide an interface for the user to make such a selection. The interface may include a list of the available microphone types that can be selected, and the user may enter a selection by many known interfacing devices and techniques. By one form, the list is fixed and lists microphone types that correspond to the microphone types of the target models in the target model library. Each model is trained from a target microphone of a specific microphone type and that therefore represents a generic microphone of that specific microphone type. As mentioned above, the microphone types may be general categories such as for a specific computing source device including a laptop, tablet, or smartphone, or a device with less computing ability such as headphones, studio mic, free-standing or WiFi mic, and so forth, or more specific microphone or source device products or brands, and so forth. Once the user makes a selection, the unifying system determines (or receives) that selection and obtains the target model associated with that selection to be used for processing.

The unified audio signal is deemed a generic audio signal since the models are trained on unknown target microphones that are not used by the current source user during a run-time. More specifically, a unified audio signal is deemed more generic than a corresponding initial audio signal when any audio signal characteristic level or measurement of the initial audio signal is modified to be closer to (or becomes more similar to) audio signal characteristic measures or levels of unknown microphone target audio signals of microphones of a microphone type that was used in a microphone type training dataset during training of a unifying neural network to represent a generic microphone type. Note that this does not require the differences between the unified audio signal characteristics and a generic audio signal characteristics to be smaller than the differences between the unified audio signal characteristics and the initial audio signal characteristics, although they can be. Rather, this merely refers to at least one of the unified audio signal characteristics being changed to be closer to a generic audio signal characteristic relative to the same characteristic of the initial audio signal. Herein, the characteristics of the unknown microphone used as a target microphone for training to represent a specific microphone type may be referred to as a target microphone profile that represents, or is, a generic profile of the generic microphone and generic audio signal for a specific microphone type.

When the list is fixed, the microphone types are listed whether or not any particular microphone type is actually coupled to the network being used by the source user. When the manual selection is being used with a fixed target microphone type list, no device tracking is needed solely for the target model selection.

By an alternative form, however, the list could be modified or updated by the system providing the unifying and/or hosting device for example. This may involve the system with the unifying (or host) device having access to source device (or microphone) tracking that tracks source devices that join or drop from the network using the unifying device and identifies the type of microphone of the source devices. The identification of the microphone type may be assumed simply by the type of source device, such as when a laptop joins the conference, it may be assumed built-in internal microphones are being used on the laptop. Otherwise, microphone detection techniques may be used that actually detect the specific microphone type, such as when a source user attaches headphones to the laptop. The system then may adjust the list to reflect which source devices are on the network with the unifying device. In this case, the source user still may be selecting the desired microphone type from the updated list.

Note also that whether or not the target microphone type list is fixed, the PSU operations do not need source device tracking solely to generate unified audio signals. Thus, by one form, the unified audio signal generation is simply applied with the selected target model and to whichever initial audio signal is received.

It is expected that at the start of a video or phone conference, or other event or session using the unifying device, and for a particular source device and source user, usually the selection of a target microphone type will begin with a current, first, or start microphone type. By one example use, then, this selection is not changed during the conference. For example, built-in microphones on a laptop may be used first, and the user then switches to a headphone coupled to the laptop and with an inline cable microphone, and then switches to the user's smartphone. In this case, the unifying device with the PSU makes the second and third devices (the head phones and smart phone, sound more like the built-in laptop microphones (or more generic) to a user at an output device so that the microphone switching remains more difficult to detect for a user at the output device. It should be noted that in one form, even the first device, here the laptop, will cause the PSU to output unified audio signals to be provided to the output device.

By another option, however, and whether manually by the user or automatically by the system, a target microphone type selection may be made before, during, or after each time a user changes the microphone type being used. The target microphone type selection in this case may be performed in order to match the older or previous microphone type. Thus, continuing the example sequence of microphone types from above, the first microphone type (e.g., built-in laptop mics) should be selected so that the generated unified audio signals sound more like the built-in laptop mics no matter the device the laptop subsequently may be changed to. Thereafter, after the change is made to the headphones, the microphone type may be changed to headphone mics so that now if the microphone type is changed again, the unified audio signals will sound more like headphone microphones no matter which microphone type is subsequently used after the headphones, and so on. It is of course possible that an output user at an output device still will detect the change from unified audio signals of one microphone type to unified audio signals of another microphone type, but it is assumed this change should usually be less detectable then changes in typical audio signals without the use of the unified audio signals.

Otherwise, the user or system could switch among the target microphone type models when the resulting unified signals do not meet a certain threshold, or to specifically improve the quality of the output audio. Thus, for example, when using headphone microphones, the user may select studio microphone when the resulting audio output provides a better experience for the output user at an output device. It should be noted, however, this does not change the fact that the selected neural work or model of the PSU still outputs a unified audio signal that is more generic than an input initial audio signal, and therefore sounds more similar to unified audio signals of any other available microphones on the other source devices, and regardless of the quality of the audio signal for any particular microphone type.

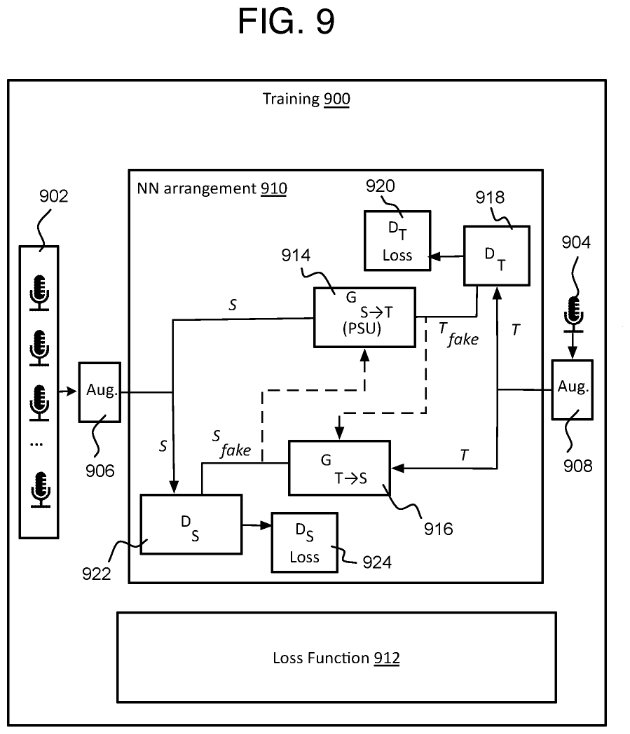

By yet another example alternative, the training may be available for the run-time devices, and in this case, the microphone type list may list specific microphones being used by a user. The audio system would need to have the capacity to store and run the training unit described herein (FIG. 9) whether on one of the source device, host device, unifying device, or other networked component. Also, whether manually or automatically, this would also involve updating the microphone type model library to include the actual available microphones on the source devices.

As yet another alternative, instead of the library of target models only including target datasets for different types of microphones, instead, or additionally, the library could include at least some target datasets that relate to a different audio characteristic such as room (e.g., acoustic) characteristics, indoor or outdoor location, change in distance to the microphone that is perceived on the other side of call, specific noises, denoised signals, and so forth.

Process 600 next may include “modify the initial audio signal” 608”, and this refers to the operation of the unifying neural network operated by the PSU. As a preliminary matter, and whether performed as part of the receiving operation 602 above or here as part of the modifying operation, the initial audio signals may be formatted to a format expected by the unifying neural network. Thus, initial audio signals may be provided at an example sampling rate such as 16 kHz, 48 kHz, 96 kHz, and so forth. By one form, the sample delivery rate by a driver could be slower, such as 10 ms, while an input format or STFT unit buffers the audio data to collect samples to operate at a different rate, such as 32 ms frames. Thus, an input format unit may divide (or combine) the initial samples into frames, if necessary, and expected by the NN, and by one form into example frames of 32 ms with hops of 8 ms. Hops may or may not be used, and many different frame and hop durations may be used.

Thereafter, STFT may be applied to convert the frames into the frequency domain. The STFT may simultaneously or subsequently perform feature extraction to obtain frequency-domain audio signals and compute a version of the audio signals that can be used by the unifying NN to generate unified audio signals. By one example, this may involve generating feature vectors of Mel-spectrum related values, such as Mel-frequency cepstrum coefficients (MFCCs) or by using a latent domain obtained through a learnable encoder-decoder. By one example then, every frame may have a feature vector of Mel-frequency band values, such as 120 bands in this example. These feature vectors of consecutive frames of a single audio signal then may be collected into a 2D surface to be input into an input layer of the NN as described below.

The modifying operation 608 then may include “obtain selected microphone type target model” 610. This may involve looking up which target microphone type was selected and then obtaining the corresponding model from the library. The model's parameters then may be loaded onto the input buffers of the hardware or firmware that can be used to operate the neural network of the selected model.

The modifying operation 608 may include “use at least one neural network (NN) to generate a unified audio signal that is more generic to a type of microphone than the initial audio signal” 612. As explained above, the NN inherently models a generic audio signal and modifies the initial audio signals to be more similar (changed to be closer to) the generic audio signal. Thus, as explained above, the unified audio signals of different microphones will sound more alike than the how two initial audio signals from those same microphones sound relative to each other, and this will be true regardless of which of the multiple microphones provided the initial audio signal.

The unifying neural network may be a U-net type of neural network, and by one specific example, a NN from a cycleGAN NN arrangement, as one example architecture and the specifications of the NN are described below. The initial audio signal obtained from a source device as described above may be input to the neural network, which is trained to output the unified audio signal. Ass explained above, the unified audio signal may have characteristics that are more similar or the same to audio signal characteristics of unified audio signals of any other source device, and in turn microphone, available to provide initial audio signals to the neural network. Thus, available here refers to being coupled to a network with, or on a device with, the unifying device, and in turn PSU, and the unifying neural network, and is capable of providing an initial audio signal to the unifying neural network due to the coupling with the PSU for example.

The neural network modifies the acoustic characteristics of the initial audio signals, such as the frequency response, the SNR, the total harmonic distortion, and/or other characteristics included in these three characteristics or other characteristics as mentioned above, to be more like a generic audio signal of a generic microphone of a certain microphone type. Since the initial audio signals of all of the microphones of the various source devices will have their initial audio signals modified to be more like those of such a generic microphone, the resulting unified audio signals of the various multiple microphones will sound more alike at the output device emitting the audio.

Process 600 optionally may include “provide the modified audio signal to be used at an audio output device or an audio processing application” 614. This preliminarily may include encoding the unified audio signal and then transmitting the unified audio signal to another device, such as a remote output device, to be emitted, or for further audio processing, as mentioned herein, and rather than, or in addition to, being emitted whether remotely or locally. Otherwise, this operation involves using the unified audio signal, whether or not compressed and transmitted, for ASR, SR, AoA detection, beam forming, and any other desired audio processing or enhancement application.

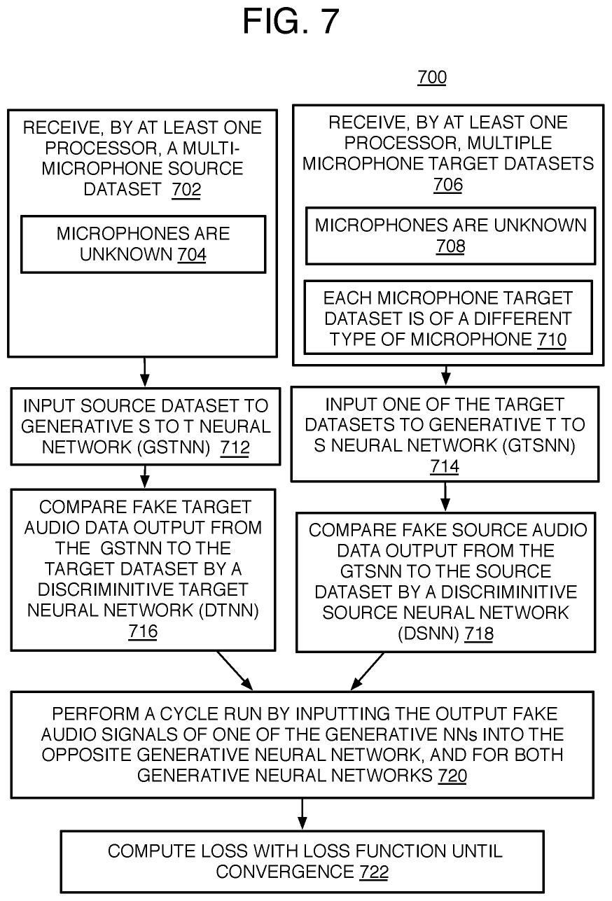

Referring to FIG. 7, an example process 700 to train a neural network of a multi-microphone audio signal unifier to generate unified or modified audio signals is provided. In the illustrated implementation, process 700 may include one or more operations, functions, or actions as illustrated by one or more of operations 702 to 722 at least generally numbered evenly. By way of non-limiting example, process 700 may be described herein with reference to example systems or environments 100, 200, 300, 400, 500, and 1100, training datasets 800, and networks 900 and 1000 described herein with FIGS. 1-5, 8-11, or any of the other systems, processes, environments, or networks described herein, and where relevant.

For a source side of the training, process 700 may include “receive, by at least one processor, a multi-microphone source dataset” 702, where the “microphones are unknown” 704. To maximize the number of possible target microphones (target datasets), the training may include sequential recording of a source corpus in a stable environment, i.e., with a fixed configuration of the microphone, speaker, and location within a room. Then, the characteristics of the microphone used for the recordings will be the dominant factor, and the unifying NN of the PSU will be able to extract the characteristics from the target recordings.

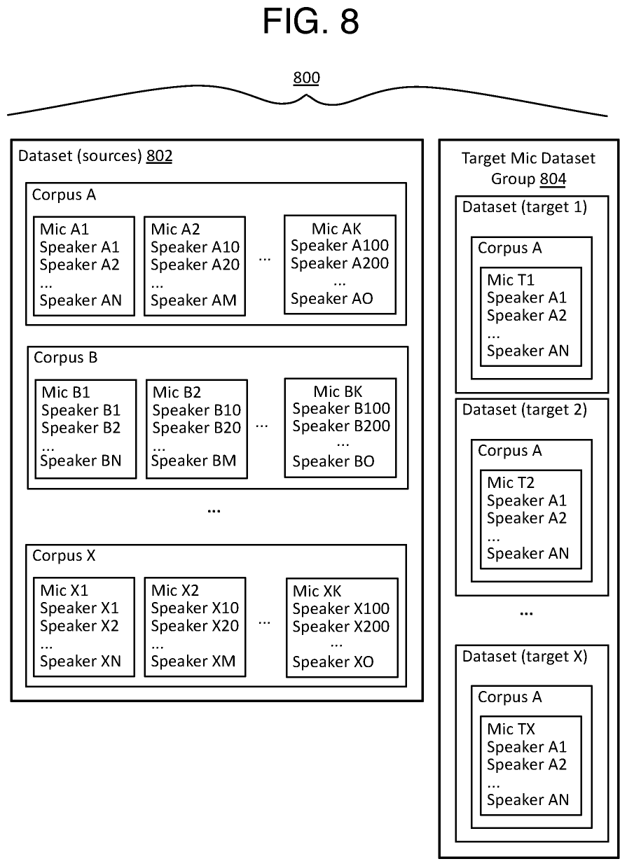

Referring to FIG. 8, an example training dataset database or collection 800 has a group of source datasets 802 and a group of target datasets 804 that may be stored in a memory as needed. The group of source datasets 802 has a group of corpuses A to X where each corpus has a set of audio samples for each microphone that was used to form the dataset. For this example, Corpus A has sets (or microphones) A1 to AK, Corpus B has sets (or microphones) B1 to BK, and so forth. By this example, each set of audio samples has samples from multiple speakers. For example, set (or microphone) A1 has samples by speakers A1 to AN, where each speaker has at least one audio sample. By one example, the source dataset 802 is at least partially based on the Libravox dataset but other datasets can be used instead, or in addition, such as Voices, Speech Accent Dataset, Speech Commands Dataset, VoxCeleb, and so forth. Multiple speakers are used to force the neural network to concentrate on the non-content parameters of the audio signals.

Likewise for a target side of the training, process 700 may include “receive, by at least one processor, multiple microphone target datasets” 706, where the “microphones are unknown” 708. The target training dataset may be created offline during the manufacturing process, so that no training occurs at the end-user or user source devices, and the user's devices are not needed for training (the training is performed on unknown microphones and source devices). Here, a target dataset may be created using an audio-video corpus for multimodal automatic speech recognition. This corpus may be recorded in one room with a single microphone to capture speech from multiple speakers. This operation may include “each microphone target dataset is of a different type of microphone” 710. Specifically, each target dataset 1 to X of the group of target datasets 804 has a single audio sample set (or microphone) T1 to TX and for a microphone that is a different type of microphone than that of the other target datasets 1 to X. Each set or microphone (T1 to TX has a multiple audio samples from multiple speakers, such as samples from speakers A1 to AN for set T1, and so forth. The different types of microphones are as described above. The number of target microphones should match the number of target NN models that will be available to the user in the target microphone library on the fully trained PSU of the run-time system. As mentioned above, each of the models will have been trained to convert any source recording to a pre-defined target profile of the target microphone used for training and that represents a generic profile of a generic microphone with a generic audio signal for a specific microphone type.

Referring to FIG. 9 to explain the example neural network architecture, an example training unit 900 to be operated by process 700 may have a NN arrangement 910 that may be used here to generate unified audio signals using a cycleGAN approach. The NN arrangement 910 has two generative (or generator) NNs or models G and two discriminative (or discriminator) NNs or models D. In the present case, the generative models include a generative source-to-target NN G_{S→T} (914) and a generative target-to-source generative NN G_{T→S} (916), while the discriminative models include a discriminative source NN D_{S} (922) and a discriminative target NN D_{T} (918). A source dataset 902 of initial microphone audios signals may be augmented by an augment unit 906, and similarly by augment unit 908 for the target dataset 904, that may perform the pre-processing and/or STFT as described above. The role of the generative model G_{S→T} is then to convert an initial microphone audio signal from a source pattern S (or source dataset) to a simulation (T_{fake}) of a target microphone pattern T that is as close as possible to the actual target microphone pattern T (from the target dataset), and vice versa for the generative NN G_{T→S}. The discriminative models D_{S} and D_{T} are then respectively trained to detect whether the fake source or fake target signal output from the generative NNs was generated by the generative model (a false or fake signal) or whether it is an actual recording made with an S or T microphone from the datasets.

For more detail, and for the two generative models or neural networks G_{S→T} and G_{T→S}, one example structure or topology may be a U-net structure, and the topology generally may have, in order, three encoding convolutional layers, three ResNet blocks, and then three decoding transpose convolutional layers. Otherwise, one different specific example of a topology that may be used is shown below in Table 1. Skip connections can be used between the convolutional and corresponding transpose convolutional layers, and batch normalization layers may be used between the ResNet blocks. By one example, an input layer may have a size of a four dimension vector with batch, channels, features, and spectra_frames_count, and for example respectively 64, 1, 256, 500. By one form, this vector provides 64 examples (or samples), where each sample may be a single channel wave file, STFT was calculated and produces 256 spectra bin, and 500 time frames. The input layer size depends on the feature extractor. An output layer may provide a unified audio signal in the form of spectral magnitudes with of transformed signal. The phase for the output signal reconstruction in the iSTFT will be obtained from the input signal. It will be understood that many different structures can be used instead.

The following is one specific example generative topology that can be used on table 1 below.

TABLE 1
GENERATIVE TOPOLOGY

| Layer | | In | Out | Ker- | | Pad- |
|---|---|---|---|---|---|---|
| ID | Layer Type | Channels | Channels | nel | Stride | ding |
| 1 | Conv2d | 1 | 64 | (4.4) | (2.2) | (1.1) |
| 2 | LeakyReLU | 64 | 64 | N/A | N/A | N/A |
| 3 | Conv2d | 64 | 128 | (4.4) | (2.2) | (1.1) |
| 4 | InstanceNorm2d | 128 | 128 | N/A | N/A | N/A |
| 5 | LeakyReLU | 128 | 128 | N/A | N/A | N/A |
| 6 | Conv2d | 128 | 256 | (4.4) | (2.2) | (1.1) |
| 7 | InstanceNorm2d | 256 | 256 | N/A | N/A | N/A |
| 8 | LeakyReLU | 256 | 256 | N/A | N/A | N/A |
| 9 | Conv2d | 256 | 512 | (4.4) | (2.2) | (1.1) |
| 10 | InstanceNorm2d | 512 | 512 | N/A | N/A | N/A |
| 11 | LeakyReLU | 512 | 512 | N/A | N/A | N/A |
| 12 | Conv2d | 256 | 512 | (4.4) | (2.2) | (1.1) |
| 13 | InstanceNorm2d | 512 | 512 | N/A | N/A | N/A |
| 14 | LeakyReLU | 512 | 512 | N/A | N/A | N/A |
| 15 | Conv2d | 256 | 512 | (4.4) | (2.2) | (1.1) |
| 16 | InstanceNorm2d | 512 | 512 | N/A | N/A | N/A |
| 17 | LeakyReLU | 512 | 512 | N/A | N/A | N/A |
| 18 | Conv2d | 512 | 512 | (4.4) | (2.2) | (1.1) |
| 19 | ReLU | 512 | 512 | N/A | N/A | N/A |
| 20 | ConvTranspose2d | 512 | 512 | (4.4) | (2.2) | (1.1) |
| 21 | InstanceNorm2d | 512 | 512 | N/A | N/A | N/A |
| 22 | ReLU | 512 | 512 | N/A | N/A | N/A |
| 23 | ConvTranspose2d | 1024 | 512 | (4.4) | (2.2) | (1.1) |
| 24 | InstanceNorm2d | 512 | 512 | N/A | N/A | N/A |
| 25 | ReLU | 1024 | 1024 | N/A | N/A | N/A |
| 26 | ConvTranspose2d | 1024 | 512 | (4.4) | (2.2) | (1.1) |
| 27 | InstanceNorm2d | 512 | 512 | N/A | N/A | N/A |
| 28 | ReLU | 1024 | 1024 | N/A | N/A | N/A |
| 29 | ConvTranspose2d | 1024 | 256 | (4.4) | (2.2) | (1.1) |
| 30 | InstanceNorm2d | 256 | 256 | N/A | N/A | N/A |
| 31 | ReLU | 512 | 512 | N/A | N/A | N/A |
| 32 | ConvTranspose2d | 512 | 128 | (4.4) | (2.2) | (1.1) |
| 33 | InstanceNorm2d | 128 | 128 | N/A | N/A | N/A |
| 34 | ReLU | 256 | 256 | N/A | N/A | N/A |
| 35 | ConvTranspose2d | 256 | 64 | (4.4) | (2.2) | (1.1) |
| 36 | InstanceNorm2d | 64 | 64 | N/A | N/A | N/A |
| 37 | ReLU | 128 | 128 | N/A | N/A | N/A |
| 38 | ConvTranspose2d | 128 | 1 | (4.4) | (2.2) | (1.1) |
| 39 | Tanh | N/A | N/A | N/A | N/A | N/A |

It will be understood, however, that many different topologies could be used instead.

For the discriminative models or neural networks D_{S} and D_{T}, one example structure may include four fully-connected convolutional layers with a batch normalization layer between each two consecutive layers. One specific example topology that can be used is shown below on a table 2 as follows:

TABLE 2
DISCRIMINITIVE TOPOLOGY

| Layer | | In | Out | | | |
|---|---|---|---|---|---|---|
| ID | Layer Type | Channels | Channels | Kernel | Stride | Padding |
| 1 | Conv2d | 1 | 64 | (4.4) | (2.2) | (1.1) |
| 2 | LeakyReLU | 64 | 64 | N/A | N/A | N/A |
| 3 | Conv2d | 64 | 128 | (4.4) | (2.2) | (1.1) |
| 4 | InstanceNorm2d | 128 | 128 | N/A | N/A | N/A |
| 5 | LeakyReLU | 128 | 128 | N/A | N/A | N/A |
| 6 | Conv2d | 128 | 256 | (4.4) | (2.2) | (1.1) |
| 7 | InstanceNorm2d | 256 | 256 | N/A | N/A | N/A |
| 8 | LeakyReLU | 256 | 256 | N/A | N/A | N/A |
| 9 | Conv2d | 256 | 512 | (4.4) | (1.1) | (1.1) |
| 10 | InstanceNorm2d | 512 | 512 | N/A | N/A | N/A |
| 11 | LeakyReLU | 512 | 512 | N/A | N/A | N/A |
| 12 | Conv2d | 512 | 1 | (4.4) | (1.1) | (1.1) |

It will be understood that many different topologies can be used instead.

Process 700 then may include “input source dataset to generative S to T neural network (GSTNN [or G_{T→S}])” 712, and “input one of the target datasets to generative T to S neural network (GTSNN [or G_{S→T}])” 714. By one form, a particular source dataset may be used with only a particular target dataset, or group of target datasets. By another form, the generative NNs are run for the entire source dataset 802 and repeated for each target dataset 1 to X to be used for a different type of target microphone. The output of the G_{T→S} is the simulated or fake target audio signals T_{fake}, while the output of the G_{T→S} is the simulated or fake source audio signals S_{fake}.

Process 700 may include “compare fake target audio data output from the GSTNN to the target dataset by a discriminative target neural network (DTNN [or D_{T}])” 716. Here, the discriminative target NN D_{T} compares the fake target audio signals T_{fake} to the actual target dataset T, or more precisely the actual collection of target audio samples or signals that form the dataset T. The output of the discriminative NN D_{T} may be a binary decision (0/1) that indicates if a fake target audio signals T_{fake} is found to be fake or real. A discriminative loss then may be computed by the discriminative D_{T} loss unit 920.

Similarly, process 700 may include “compare fake source audio data output from GTSNN to the source dataset by a discriminative source neural network (DSNN [or D_{S}])” 718. Here, the discriminative target NN D_{S} compares the fake source audio signals S_{fake} to the actual source dataset S, or more precisely the actual collection of source audio samples or signals that form the dataset S. Here too, the output of the NN D_{S} is may be a binary decision (0/1) that indicates if a fake target audio signals S_{fake} is found to be fake or real. A discriminative loss than may be computed by the discriminative D_{S} loss unit 924.

Process 700 then may include “perform a cycle run by inputting the output fake audio signals of one of the generative NNs into the opposite generative NN, and for both generative NNs” 720. This is shown by the dashed arrows on NN arrangement 910. Thus, in order to compute loss in cycle coherence (or consistency), the fake output from one of the generative NNs is placed in the other of the generative NNs, and vice-versa. As described below, the output then may be compared to the initial audio signal s or t used to form the fake audio signals in the first place.

Process 700 next may include “compute loss with loss function until convergence” 722. Here, once the NN arrangement 910 is run for a particular number of epochs or a certain duration such as 100 epochs, a loss function unit 912 may compute a total loss to determine whether or not the NN arrangement 910 has come to a convergence, and the generative source-to-target NN has been fully trained and is ready for a run-time. As noted, the NN arrangement 910 uses unpaired data where there is no synchronized pairs of audio signals recorded with different microphones whether within the same dataset or between the source and target datasets. Also, the NN arrangement 910 is unsupervised so that there is no previously established direct synchronized pairing (as in supervised training) between audio signals at the input and output of any of the neural networks being used in the NN arrangement 910, in this example. In the training of the generative NN or models (G_{T→S} and G_{S→T}), the generative models themselves (G_{T→S} and G_{S→T}) can be considered to be paired to each other, and the loss function is not based solely on the comparison of the output fake or estimated audios signals and the target microphone audio signals. Instead, this is only one part of the loss computation, and the present loss function computes losses as a combination of adversarial losses and cycle coherence losses. For both loss functions (adversarial and cycle), the results from the discriminative models and recoding from one domain to another (from source to target and vice versa) are sufficient to obtain a more accurate loss value. Loss may be computed by using the following equations:

$${GAN}_{} ( {G}_{S \to T} , {D}_{T} , S , T ) = [ log ( {D}_{T} ( t ) ) ] + [ log ( 1 - {D}_{T} ( {G}_{S \to T} ( s ) ) ] \qquad ( 1 )$$

$${GAN}_{} ( {G}_{T \to S} , {D}_{S} , S , T ) = [ log ( {D}_{S} ( s ) ) ] + [ log ( 1 - {D}_{S} ( {G}_{T \to S} ( t ) ) ) ] \qquad ( 2 )$$

$${Cycle}_{} ( {G}_{S \to T} , {G}_{T \to S} , T , S ) = [ {‖ {G}_{T \to S} ( {G}_{S \to T} ( s ) ) - s ‖}_{1} ] + [ {‖ {G}_{S \to T} ( {G}_{T \to S} ( t ) ) - t ‖}_{1} ] \qquad ( 3 )$$

$$( {G}_{S \to T} , {G}_{T \to S} , {D}_{T} , {D}_{S} ) = {GAN}_{} ( {G}_{S \to T} , {D}_{T} , S , T ) + {GAN}_{} ( {G}_{T \to S} , {D}_{S} , S , T ) + λ {Cycle}_{} ( {G}_{S \to T} , {G}_{T \to S} , T , S ) \qquad ( 4 )$$

where S is the source pattern or source dataset, s is an input initial audio signal of S, T is the target pattern or target dataset, and t is an input initial audio signal of T. A constant λ, here being 10 in the current example, is determined by experimentation. Also, [symbol] [ ] is an expected average value, and the double line subscript 1 refers to L1 normalization.

Thus, by one example form, only the results from the discriminative models D_{T} and D_{S} are used to calculate the adversarial losses [symbol] _{GAN} and audio signal data is not needed directly for the loss computation. As to the cycle coherency loss [symbol] _{Cycle}, as mentioned, the output from one of the generative models is input to the other generative model and then compared to the audio signals of the actual dataset (s or t) of that other or second generative model. In other words, the results from one domain (S or T) are being compared to the other domain. The values or results from the three loss functions (equations 1 to 3) are then summed to obtain a total loss function. When the resulting sum of the total loss function reaches a minimum value, the NN or model is then tested or validated with a validation dataset. If the test is satisfied, then the generative source-to-target NN will be deemed sufficiently converged and ready for run-time operations.

Thus, by using the NN arrangement 910, it should be noted that the unifying NN (the generative source-to-target NN) converts an initial audio signal captured by any source microphone into an audio signal close to an audio signal (or target audio signal profile) of a defined target microphone type that represents a generic microphone for that microphone type. Thus, the characteristics or profile of the unified audio signals output by the generative source-to-target NN (or unifying NN) are adjusted from an initial audio signal characteristic and to be closer to the profile of a generic audio signal of a generic microphone of a specific microphone type. As a result, the resulting unified audio signals of the source microphones used for a network or conference during run-time will have characteristics more similar to each other compared to the similarities of the characteristics among initial audio signals of the source microphones.

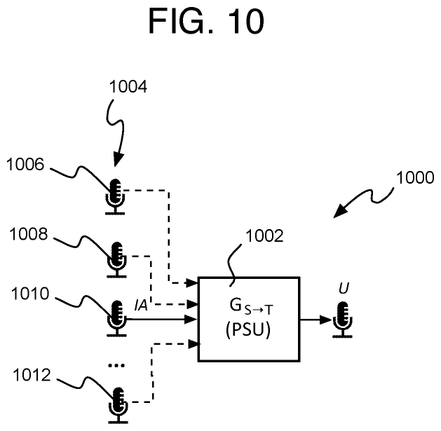

Referring to FIG. 10, a run-time NN setup 1000 may have the now fully trained generative source-to-target NN 1002 on a PSU to be used during a run-time. The other components of the training NN arrangement 910 are not used during the run-time. The NN 1002 may receive an initial audio signal IA from any one of the microphone or source devices 1006 to 1012 in a set of the devices 1004. The output is a unified audio signal U as described above.

While implementation of the example processes 600 and 700 as well as setups, devices, networks, and systems 100, 200, 300, 400, 500, 700, 800, 900, and 1000 discussed herein may include the undertaking of all operations shown in the order illustrated, the present disclosure is not limited in this regard and, in various examples, implementation of the example processes herein may include only a subset of the operations shown, operations performed in a different order than illustrated, or additional or less operations.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more graphics processing unit(s) or processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the operations discussed herein and/or any portions of the devices, systems, or any module or component as discussed herein.

As used in any implementation described herein, the term “module” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

As used in any implementation described herein, the term “logic unit” refers to any combination of firmware logic and/or hardware logic configured to provide the functionality described herein. The logic units may, collectively or individually, be embodied as circuitry that forms part of a larger system, for example, an integrated circuit (IC), system on-chip (SoC), and so forth. For example, a logic unit may be embodied in logic circuitry for the implementation firmware or hardware of the coding systems discussed herein. One of ordinary skill in the art will appreciate that operations performed by hardware and/or firmware may alternatively be implemented via software, which may be embodied as a software package, code and/or instruction set or instructions, and also appreciate that logic unit may also utilize a portion of software to implement its functionality. Other than the term “logic unit”, the term “unit” refers to any one or combination of software logic, firmware logic, hardware logic, and/or circuitry configured to provide the functionality described herein.

As used in any implementation described herein, the term “component” may refer to a module, unit, or logic unit, as these terms are described above. Accordingly, the term “component” may refer to any combination of software logic, firmware logic, and/or hardware logic configured to provide the functionality described herein. For example, one of ordinary skill in the art will appreciate that operations performed by hardware and/or firmware may alternatively be implemented via a software module, which may be embodied as a software package, code and/or instruction set, and also appreciate that a logic unit may also utilize a portion of software to implement its functionality.

The terms “circuit” or “circuitry,” as used in any implementation herein, may comprise or form, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor (“processor circuitry”) and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smartphones, etc. Other implementations may be implemented as software executed by a programmable control device. In such cases, the terms “circuit” or “circuitry” are intended to include a combination of software and hardware such as a programmable control device or a processor capable of executing the software. As described herein, various implementations may be implemented using hardware elements, software elements, or any combination thereof that form the circuits, circuitry, and processor circuitry. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

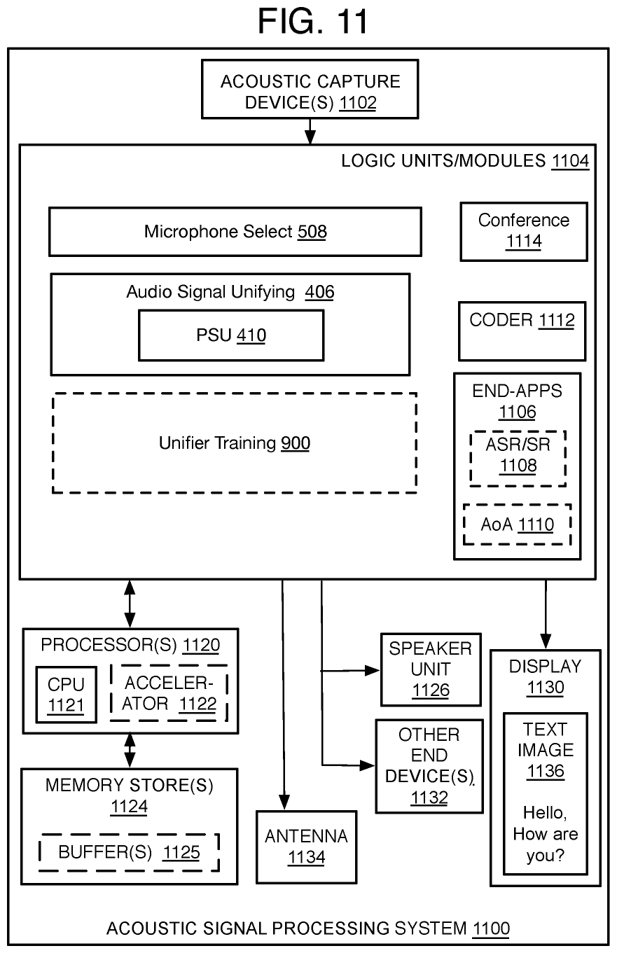

Referring to FIG. 11, an example acoustic signal processing system 1100 is arranged in accordance with at least some implementations of the present disclosure. In various implementations, the example acoustic signal processing system 1100 may have acoustic capture devices 1102, such as listening or source devices described herein, and has one or more microphones to receive acoustic waves and form acoustical signal data. This can be implemented in various ways. Thus, in one form, the acoustic signal processing system 1100 is one of the listening devices, or is on a device, with one or more microphones. In other examples, the acoustic signal processing system 1100 may be in communication with one or an array or network of listening devices 1102 with microphones, or in communication with at least two microphones. The system 1100 may be remote from these acoustic signal capture devices 1102 such that logic modules 1104 may communicate remotely with, or otherwise may be communicatively coupled to, the microphones for further processing of the acoustic data. In this case, the logic modules 1104 may be part of, or on, a host device a unifying device or a device that combines the two.

In either case, such technology may include a smart phone, smart speaker, a tablet, laptop or other computer, video or phone conference console, dictation machine, other sound recording machine, a mobile device or an on-board device, or any combination of these. Thus, in one form, audio capture devices 1102 may include audio capture hardware including one or more sensors as well as actuator controls. These controls may be part of a sensor module or component for operating the sensor. The sensor component may be part of the audio capture device 1102, or may be part of the logical modules 1104 or both. Such sensor component can be used to convert sound waves into an electrical acoustic signal. The audio capture device 1102 also may have an A/D converter, AEC unit, other filters, and so forth to provide a digital signal for acoustic signal processing.

In the illustrated example, the logic units and modules 1104 may include the microphone selection unit 508, the audio signal unifying unit 406 with the PSU 410, and/or a unifier training unit 900 when the system or device 1100 is to be used for training as described above, and in addition to, or instead of, being used during a run-time. When the logic modules 1104 are on a host device, the logic modules 1104 also may include a conference unit 1114 to host and operate a video or phone conference system as mentioned herein. For transmission and emission of the audio, the system 1100 may have a coder unit 1112 for encoding and an antenna 1134 for transmission to a remote output device, as well as a speaker 1126 for local emission.

The logic modules 1104 also may include an end-apps unit 1106 to perform further audio processing such as with an ASR/SR unit 1108, an AoA unit 1110 (or a beam-forming unit), and/or other end applications that may be provided to analyze and otherwise use the audio signals with best or better audio quality scores. The logic modules 1104 also may include other end devices 1132, which may include a decoder to decode input signals when audio is received via transmission, and if not already provided with coder unit 1112. These units may be used to perform the operations described above where relevant. The tasks performed by these units or components are indicated by their labels and may perform similar tasks as those units with similar labels as described above.

The acoustic signal processing system 1100 may have processor circuitry 1120 forming one or more processors which may include central processing unit (CPU) 1121 and/or one or more dedicated accelerators 1122 such as the Intel Atom, memory stores 1124 with one or more buffers 1125 to hold audio-related data such as audio signal samples, a target model library, and so forth as described above, at least one speaker unit 1126 to emit audio based on the input audio signals, or responses thereto, when desired, one or more displays 1130 to provide images 1136 of text for example, as a visual response to the acoustic signals. The other end device(s) 1132 also may perform actions in response to the acoustic signal. In one example implementation, the acoustic signal processing system 1100 may have the at least one processor of the processor circuitry 1120 communicatively coupled to the acoustic capture device(s) 1102 (such as at least two microphones of one or more listening devices) and at least one memory 1124. As illustrated, any of these components may be capable of communication with one another and/or communication with portions of logic modules 1104 and/or audio capture device 1102. Thus, processors of processor circuitry 1120 may be communicatively coupled to the audio capture device 1102, the logic modules 1104, and the memory 1124 for operating those components.

While typically the label of the units or blocks on device 1100 at least indicates which functions are performed by that unit, a unit may perform additional functions or a mix of functions that are not all suggested by the unit label. Also, although acoustic signal processing system 1100, as shown in FIG. 11, may include one particular set of units or actions associated with particular components or modules, these units or actions may be associated with different components or modules than the particular component or module illustrated here,

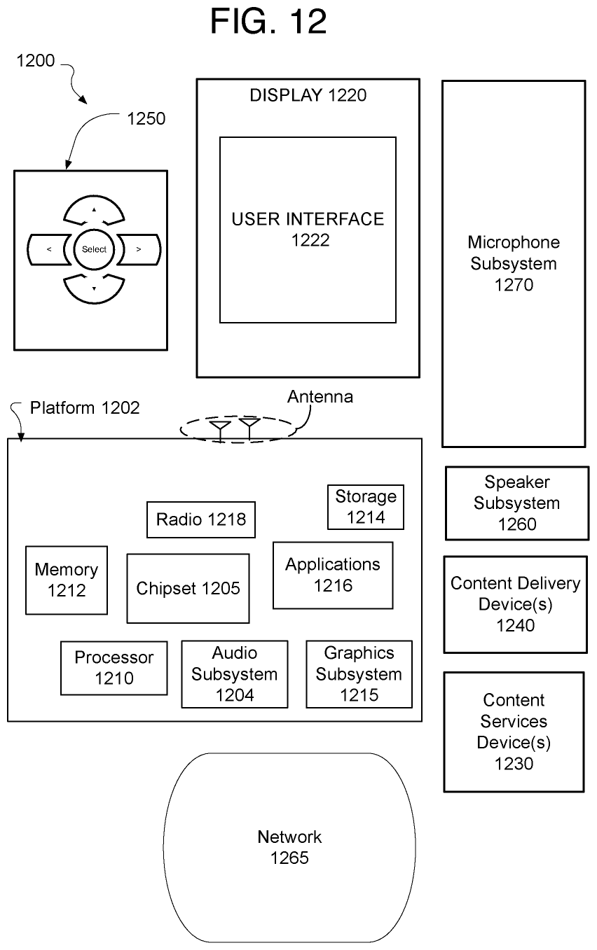

Referring to FIG. 12, an example system 1200 in accordance with the present disclosure operates one or more aspects of the audio processing system described herein including that of system 1100 (FIG. 11). It will be understood from the nature of the system components described below that such components may be associated with, or used to operate, certain part or parts of the speech processing system described above. In various implementations, system 1200 may be a media system although system 1200 is not limited to this context. For example, system 1200 may be incorporated into multiple microphones of a network of microphones on listening devices, personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth, but otherwise any device having a network of acoustic signal producing devices.

In various implementations, system 1200 includes a platform 1202 coupled to a display 1220. Platform 1202 may receive content from a content device such as content services device(s) 1230 or content delivery device(s) 1240 or other similar content sources. A navigation controller 1250 including one or more navigation features may be used to interact with, for example, platform 1202, speaker subsystem 1260, microphone subsystem 1270, and/or display 1220. Each of these components is described in greater detail below.

In various implementations, platform 1202 may include any combination of a chipset 1205, processor 1210, memory 1212, storage 1214, audio subsystem 1204, graphics subsystem 1215, applications 1216 and/or radio 1218. Chipset 1205 may provide intercommunication among processor 1210, memory 1212, storage 1214, audio subsystem 1204, graphics subsystem 1215, applications 1216 and/or radio 1218. For example, chipset 1205 may include a storage adapter (not depicted) capable of providing intercommunication with storage 1214. Either audio subsystem 1204 or the microphone subsystem 1270 may have the microphone type (or target model) selection unit described herein. Otherwise, the system 1200 may be or have one of the listening devices.

Processor 1210 may be implemented as a Complex Instruction Set Computer (CISC) or Reduced Instruction Set Computer (RISC) processors; x86 instruction set compatible processors, multi-core, or any other microprocessor or central processing unit (CPU). In various implementations, processor 1210 may be dual-core processor(s), dual-core mobile processor(s), and so forth.

Memory 1212 may be implemented as a volatile memory device such as, but not limited to, a Random Access Memory (RAM), Dynamic Random Access Memory (DRAM), or Static RAM (SRAM).

Storage 1214 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 1214 may include technology to increase the storage performance enhanced protection for valuable digital media when multiple hard drives are included, for example.

Audio subsystem 1204 may perform processing of audio such as acoustic signals for one or more audio-based applications such as audio signal enhancement, microphone switching as described herein, speech recognition, speaker recognition, and so forth. The audio subsystem 1204 may have audio conference (or the audio part of video conference) hosting modules. The audio subsystem 1204 may comprise one or more processing units, memories, and accelerators. Such an audio subsystem may be integrated into processor 1210 or chipset 1205. In some implementations, the audio subsystem 1204 may be a stand-alone card communicatively coupled to chipset 1205. An interface may be used to communicatively couple the audio subsystem 1204 to a speaker subsystem 1260, microphone subsystem 1270, and/or display 1220.

Graphics subsystem 1215 may perform processing of images such as still or video for display. Graphics subsystem 1215 may be a graphics processing unit (GPU) or a visual processing unit (VPU), for example. An analog or digital interface may be used to communicatively couple graphics subsystem 1215 and display 1220. For example, the interface may be any of a High-Definition Multimedia Interface, Display Port, wireless HDMI, and/or wireless HD compliant techniques. Graphics subsystem 1215 may be integrated into processor 1210 or chipset 1205. In some implementations, graphics subsystem 1215 may be a stand-alone card communicatively coupled to chipset 1205.

The audio processing techniques described herein may be implemented in various hardware architectures. For example, audio functionality may be integrated within a chipset. Alternatively, a discrete audio processor may be used. As still another implementation, the audio functions may be provided by a general purpose processor, including a multi-core processor. In further embodiments, the functions may be implemented in a consumer electronics device.

Radio 1218 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 1218 may operate in accordance with one or more applicable standards in any version.

In various implementations, display 1220 may include any television type monitor or display. Display 1220 may include, for example, a computer display screen, touch screen display, video monitor, television-like device, and/or a television. Display 1220 may be digital and/or analog. In various implementations, display 1220 may be a holographic display. Also, display 1220 may be a transparent surface that may receive a visual projection. Such projections may convey various forms of information, images, and/or objects. For example, such projections may be a visual overlay for a mobile augmented reality (MAR) application. Under the control of one or more software applications 1216, platform 1202 may display user interface 1222 on display 1220.

In various implementations, content services device(s) 1230 may be hosted by any national, international and/or independent service and thus accessible to platform 1202 via the Internet, for example. Content services device(s) 1230 may be coupled to platform 1202 and/or to display 1220, speaker subsystem 1260, and microphone subsystem 1270. Platform 1202 and/or content services device(s) 1230 may be coupled to a network 1265 to communicate (e.g., send and/or receive) media information to and from network 1265. Content delivery device(s) 1240 also may be coupled to platform 1202, speaker subsystem 1260, microphone subsystem 1270, and/or to display 1220.

In various implementations, content services device(s) 1230 may include a network of microphones, a cable television box, personal computer, network, telephone, Internet enabled devices or appliance capable of delivering digital information and/or content, and any other similar device capable of unidirectionally or bidirectionally communicating content between content providers and platform 1202 and speaker subsystem 1260, microphone subsystem 1270, and/or display 1220, via network 1265 or directly. It will be appreciated that the content may be communicated unidirectionally and/or bidirectionally to and from any one of the components in system 1200 and a content provider via network 1265. Examples of content may include any media information including, for example, video, music, medical and gaming information, and so forth.

Content services device(s) 1230 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 1202 may receive control signals from navigation controller 1250 having one or more navigation features. The navigation features of controller 1250 may be used to interact with user interface 1222, for example. In embodiments, navigation controller 1250 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures. The audio subsystem 1204 also may be used to control the motion of articles or selection of commands on the interface 1222.

Movements of the navigation features of controller 1250 may be replicated on a display (e.g., display 1220) by movements of a pointer, cursor, focus ring, or other visual indicators displayed on the display or by audio commands. For example, under the control of software applications 1216, the navigation features located on navigation controller 1250 may be mapped to virtual navigation features displayed on user interface 1222, for example. In embodiments, controller 1250 may not be a separate component but may be integrated into platform 1202, speaker subsystem 1260, microphone subsystem 1270, and/or display 1220. The present disclosure, however, is not limited to the elements or in the context shown or described herein.

In various implementations, drivers (not shown) may include technology to enable users to instantly turn on and off platform 1202 like a television with the touch of a button after initial boot-up, when enabled, for example, or by auditory command. Program logic may allow platform 1202 to stream content to media adaptors or other content services device(s) 1230 or content delivery device(s) 1240 even when the platform is turned “off.” In addition, chipset 1205 may include hardware and/or software support for 8.1 surround sound audio and/or high definition (7.1) surround sound audio, for example. Drivers may include an auditory or graphics driver for integrated auditory or graphics platforms. In embodiments, the auditory or graphics driver may comprise a peripheral component interconnect (PCI) Express graphics card.

In various implementations, any one or more of the components shown in system 1200 may be integrated. For example, platform 1202 and content services device(s) 1230 may be integrated, or platform 1202 and content delivery device(s) 1240 may be integrated, or platform 1202, content services device(s) 1230, and content delivery device(s) 1240 may be integrated, for example. In various embodiments, platform 1202, audio subsystem 1204, speaker subsystem 1260, and/or microphone subsystem 1270 may be an integrated unit. Display 1220, speaker subsystem 1260, and/or microphone subsystem 1270 and content service device(s) 1230 may be integrated, or display 1220, speaker subsystem 1260, and/or microphone subsystem 1270 and content delivery device(s) 1240 may be integrated, for example. These examples are not meant to limit the present disclosure.

In various implementations, system 1200 may be implemented as a wireless system, a wired system, or a combination of both. When implemented as a wireless system, system 1200 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1200 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 1202 may establish one or more logical or physical channels to communicate information. The information may include media information and control information. Media information may refer to any data representing content meant for a user. Examples of content may include, for example, data from a voice conversation, videoconference, streaming video and audio, electronic mail (“email”) message, text message, voice mail message, alphanumeric symbols, graphics, image, video, audio, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The implementations, however, are not limited to the elements or in the context shown or described in FIG. 12.

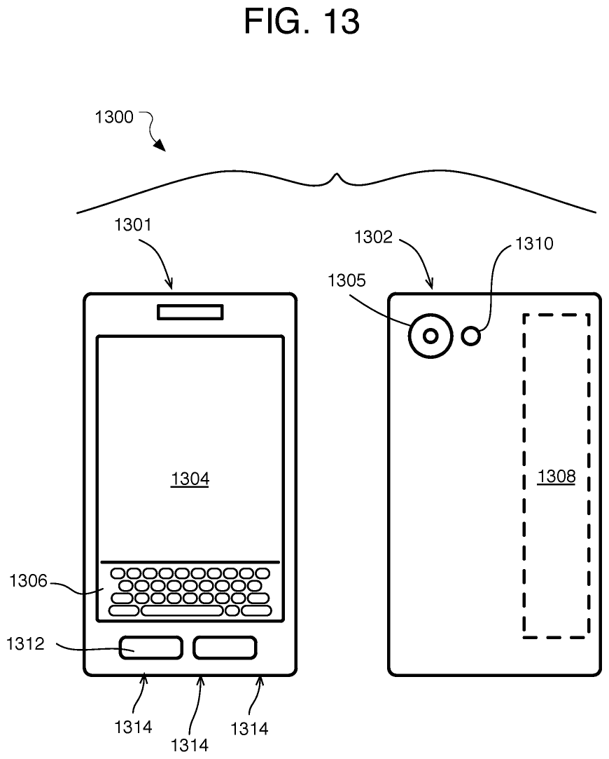

Referring to FIG. 13, a small form factor device 1300 is one example of the varying physical styles or form factors in which systems 1100 or 1200 may be embodied. By this approach, device 1300 may be implemented as a mobile computing device having wireless capabilities. A mobile computing device may refer to any device having a processing system and a mobile power source or supply, such as one or more batteries, for example.

As described above, examples of a mobile computing device may include any device with an audio sub-system such as a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet, smart speaker, or smart television), mobile internet device (MID), messaging device, data communication device, phone conference console, speaker system, microphone system or network, and so forth, and any other on-board (such as on a vehicle), or building, computer that may accept audio commands.

Examples of a mobile computing device also may include computers that are arranged to be worn by a person, such as a wrist computers, finger computers, ring computers, eyeglass computers, belt-clip computers, arm-band computers, shoe computers, clothing computers, and other wearable computers. In various implementations, for example, a mobile computing device may be implemented as a smart phone capable of executing computer applications, as well as voice communications and/or data communications. Although some implementations may be described with a mobile computing device implemented as a smart phone by way of example, it may be appreciated that other implementations may be implemented using other wireless mobile computing devices as well. The implementations are not limited in this context.

As shown in FIG. 13, device 1300 may include a housing with a front 1301 and a back 1302. Device 1300 includes a display 1304, an input/output (I/O) device 1306, and an integrated antenna 1308. Device 1300 also may include navigation features 1312. I/O device 1306 may include any suitable I/O device for entering information into a mobile computing device. Examples for I/O device 1306 may include an alphanumeric keyboard, a numeric keypad, a touch pad, input keys, buttons, switches, speakers, voice recognition device and software, and so forth. Information also may be entered into device 1300 by way of one or more microphones 1314. By one example alternative, microphones 1314 may be placed on the bottom of the smart phone as shown, in addition to two more microphones at the front and back near the top of the device 1300. As shown, device 1300 may include a camera 1305 (e.g., including a lens, an aperture, and an imaging sensor) and a flash 1310 integrated into back 1302, front 1301, or elsewhere of device 1300.

Various implementations may be implemented using hardware elements, software elements, or a combination of both. Examples of hardware elements may include processor circuitry forming processors and/or microprocessors, as well as circuits, circuit elements (e.g., transistors, resistors, capacitors, inductors, and so forth), integrated circuits, application specific integrated circuits (ASIC), programmable logic devices (PLD), digital signal processors (DSP), fixed function hardware, field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an implementation is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one implementation may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to additional implementations.

In example 1, a computer-implemented method of audio processing comprises receiving, by processor circuitry, an initial audio signal from one of multiple microphones arranged to provide the initial audio signal; and modifying the initial audio signal comprising using at least one neural network (NN) to generate a unified audio signal that is more generic to a type of microphone than the initial audio signal.

In example 2, the subject matter of example 1, wherein the modified audio signal is provided from the at least one neural network regardless of an improvement in quality of the audio signal.

In example 3, the subject matter of examples 1 or 2, wherein the unified audio signal comprises at least one characteristic of the initial audio signal modified to be closer to a frequency response, signal-to-noise ratio, or total harmonic distortion of a generic audio signal modeled by the at least one neural network and of the type of microphone.

In example 4, the subject matter any one of examples 1 to 3, wherein the method comprises switching from one target neural network model to another target neural network model of a plurality of target neural network models, and to be used as the at least one neural network during a run-time, wherein each target neural network model is associated with a different type of microphone.

In example 5, the subject matter of any one of example 1 to 4, comprising training the at least one neural network comprising inputting a source dataset into the at least one neural network that includes audio samples from multiple unknown source microphones.

In example 6, the subject matter of example 5, wherein the training comprises: inputting the source dataset into a source neural network, and comparing a target dataset to fake audio signals generated by the source neural network, wherein the target dataset comprises audio samples of unknown target microphones of a single type of audio device that are unpaired to the samples of the source dataset.

In example 7, the subject matter of any one of example 1 to 6, comprising training the at least one neural network with a cycle generative adversarial network (cycleGAN) arrangement.

In example 8, the subject matter of any one of example 1 to 7, wherein a difference in at least one characteristic of the unified audio signal and another unified audio signal of another one of the microphones is smaller than a difference of the same at least one characteristic between initial audio signals associated with the unified audio signal and the another unified audio signal.

In example 9, a computer-implemented system comprises memory to hold data associated with audio signals; and processor circuitry communicatively connected to the memory, the processor circuitry to operate by training a source neural network comprising: inputting a source dataset of source audio signals of multiple unknown microphones of multiple types of audio devices into the source neural network to generate unified audio signals more generic than the source audio signals, and operating the neural network until a loss function meets at least one criterium that indicates the unified audio signals are more generic in at least one audio signal characteristic than the at least one audio signal characteristic of the source audio signals.

In example 10, the subject matter of example 9, wherein the unified audio signals comprise at least one characteristic of a source audio signal modified to be closer to a frequency response, signal-to-noise ratio, or total harmonic distortion of a generic audio signal modeled by the at least one neural network.

In example 11, the subject matter of example 9 or 10, wherein the processor circuitry is arranged to compare a target dataset of target audio signals of one or more microphones of a single type of target audio device with the unified audio signals to provide comparison values for the loss function.

In example 12, the subject matter of example 11, wherein the comparing is performed by operating a target comparison neural network that outputs comparison values.

In example 13, the subject matter of example 12, wherein the processor circuitry is arranged to operate a cycle generative adversarial network (cycleGAN) arrangement wherein the source neural network is a generative source-to-target neural network, the unified audio signals are target fake audios signals, and the target comparison neural network is a target discriminative neural network, and wherein the cycleGAN arrangement comprises a generative target-to-source neural network that receives the target dataset as input and outputs source fake audio signals, and wherein the cycleGAN arrangement comprises a source discriminative neural network that receives both the source fake target audio signals and the source dataset as input.

In example 14, the subject matter of example 13, wherein the generative source-to-target neural network from the cycle generative adversarial network arrangement is used during a run-time.

In example 15, the subject matter of example 13, wherein the source fake audio signals are input to the generative source-to-target neural network and the target fake audio signals are input to the generative target-to-source neural network to generate cycle audio signals to be used in a cycle loss function computation.

In example 16, the subject matter of any one of examples 11 to 15, wherein audio signals of the source and target datasets are unpaired to each other.

In example 17, the subject matter of any one of examples 11 to 16, wherein the source and target audio signals respectively comprise source or target audio signals each spoken by a single person, and spoken by different people from audio signal to audio signal in the source and target datasets.

In example 18, at least one non-transitory computer readable medium comprising a plurality of instructions that in response to being executed on a computing device, causes the computing device to operate by: receiving, by processor circuitry, an initial audio signal from a microphone; and modifying the initial audio signal comprising using at least one neural network to generate a unified audio signal with at least one characteristic that is more generic to a type of microphone than the characteristic of the initial audio signal and regardless of an improvement in quality relative to the initial audio signal.

In example 19, the subject matter of example 18, wherein the instructions are arranged to cause the computing device to operate by selecting among a plurality of target neural network models to be used as the at least one neural network during a run-time, wherein each neural network model is associated with a different type of microphone.

In example 20, the subject matter of example 18, wherein the instructions are arranged to cause the computing device to operate by determining a selection among a plurality of available types of microphones, and wherein each type is associated with a different target neural network model to be used as the at least one neural network during a run-time.

In example 21, a device or system includes a memory and a processor to perform a method according to any one of the above implementations.

In example 22, at least one machine readable medium includes a plurality of instructions that in response to being executed on a computing device, cause the computing device to perform a method according to any one of the above implementations.

In example 23, an apparatus may include means for performing a method according to any one of the above implementations.

The above examples may include specific combination of features. However, the above examples are not limited in this regard and, in various implementations, the above examples may include undertaking only a subset of such features, undertaking a different order of such features, undertaking a different combination of such features, and/or undertaking additional features than those features explicitly listed. For example, all features described with respect to any example methods herein may be implemented with respect to any example apparatus, example systems, and/or example articles, and vice versa.

What is claimed is:

1. A computer-implemented method of audio processing, comprising:
receiving, by processor circuitry, an initial audio signal from one of multiple microphones arranged to provide the initial audio signal; and
modifying the initial audio signal comprising using at least one neural network (NN) to generate a unified audio signal that is more generic to a type of microphone than the initial audio signal.

2. The method of claim 1, wherein the unified audio signal is provided from the at least one neural network regardless of an improvement in quality of the audio signal.

3. The method of claim 1, wherein the unified audio signal comprises at least one characteristic of the initial audio signal modified to be closer to a frequency response, signal-to-noise ratio, or total harmonic distortion of a generic audio signal modeled by the at least one neural network and of the type of microphone.

4. The method of claim 1, comprising switching from one target neural network model to another target neural network model of a plurality of target neural network models, and to be used as the at least one neural network during a run-time, wherein each target neural network model is associated with a different type of microphone.

5. The method of claim 1, comprising training the at least one neural network comprising inputting a source dataset into the at least one neural network that includes audio samples from multiple unknown source microphones.

6. The method of claim 5, wherein the training comprises: inputting the source dataset into a source neural network, and comparing a target dataset to fake audio signals generated by the source neural network, wherein the target dataset comprises audio samples of unknown target microphones of a single type of audio device that are unpaired to the samples of the source dataset.

7. The method of claim 1, comprising training the at least one neural network with a cycle generative adversarial network (cycleGAN) arrangement.

8. The method of claim 1, wherein a difference in at least one characteristic of the unified audio signal and another unified audio signal of another one of the microphones is smaller than a difference of the same at least one characteristic between initial audio signals associated with the unified audio signal and the another unified audio signal.

9. A computer-implemented system, comprising:
memory to hold data associated with audio signals; and
processor circuitry communicatively connected to the memory, the processor circuitry to operate by training a source neural network comprising:
inputting a source dataset of source audio signals of multiple unknown microphones of multiple types of audio devices into the source neural network to generate unified audio signals more generic than the source audio signals, and
operating the neural network until a loss function meets at least one criterium that indicates the unified audio signals are more generic in at least one audio signal characteristic than the at least one audio signal characteristic of the source audio signals.

10. The system of claim 9, wherein the unified audio signals comprise at least one characteristic of a source audio signal modified to be closer to a frequency response, signal-to-noise ratio, or total harmonic distortion of a generic audio signal modeled by the at least one neural network.

11. The system of claim 9, wherein the processor circuitry is arranged to compare a target dataset of target audio signals of one or more microphones of a single type of target audio device with the unified audio signals to provide comparison values for the loss function.

12. The system of claim 11, wherein the comparing is performed by operating a target comparison neural network that outputs comparison values.

13. The system of claim 12, wherein the processor circuitry is arranged to operate a cycle generative adversarial network (cycleGAN) arrangement wherein the source neural network is a generative source-to-target neural network, the unified audio signals are target fake audios signals, and the target comparison neural network is a target discriminative neural network, and wherein the cycleGAN arrangement comprises a generative target-to-source neural network that receives the target dataset as input and outputs source fake audio signals, and wherein the cycleGAN arrangement comprises a source discriminative neural network that receives both the source fake target audio signals and the source dataset as input.

14. The system of claim 13, wherein the generative source-to-target neural network from the cycle generative adversarial network arrangement is used during a run-time.

15. The system of claim 13, wherein the source fake audio signals are input to the generative source-to-target neural network and the target fake audio signals are input to the generative target-to-source neural network to generate cycle audio signals to be used in a cycle loss function computation.

16. The system of claim 11, wherein audio signals of the source and target datasets are unpaired to each other.

17. The system of claim 11 wherein the source and target audio signals respectively comprise source or target audio signals each spoken by a single person, and spoken by different people from audio signal to audio signal in the source and target datasets.

18. At least one non-transitory computer readable medium comprising a plurality of instructions that in response to being executed on a computing device, causes the computing device to operate by:
receiving, by processor circuitry, an initial audio signal from a microphone; and
modifying the initial audio signal comprising using at least one neural network to generate a unified audio signal with at least one characteristic that is more generic to a type of microphone than the characteristic of the initial audio signal and regardless of an improvement in quality relative to the initial audio signal.

19. The medium of claim 18, wherein the instructions are arranged to cause the computing device to operate by selecting among a plurality of target neural network models to be used as the at least one neural network during a run-time, wherein each neural network model is associated with a different type of microphone.

20. The medium of claim 18, wherein the instructions are arranged to cause the computing device to operate by determining a selection among a plurality of available types of microphones, and wherein each type is associated with a different target neural network model to be used as the at least one neural network during a run-time.
